(19) United States
(12) Patent Application Publication
(10) Pub. No.: US 2010/0096987 A1
(43) Pub. Date: Apr. 22, 2010

(54) PLASMA DISPLAY PANEL AND FABRICATION METHOD THEREOF

(76) Inventor: Chong-Gi Hong, Suwon-si (KR)

Correspondence Address: CHRISTIE, PARKER & HALE, LLP, PO BOX 7068, PASADENA, CA, 91109-7068, US

(21) Appl. No.: 12/582,536

(22) Filed: Oct. 20, 2009

(30) Foreign Application Priority Data
Oct. 20, 2008 (KR) 10-2008-0102556

(51) Int. Cl. H01J 17/49; H01J 9/00

(52) U.S. Cl. 313/582; 445/24

(57) ABSTRACT

A plasma display panel and method of fabricating the same are disclosed. The method includes: preparing a base substrate to be divided into unit substrates; forming discharge electrodes and a dielectric layer covering the discharge electrodes on the unit substrates; patterning barrier ribs, which include main barrier ribs in a display area and dummy barrier ribs in a non-display area, on the dielectric layer; and dividing the base substrate along borders of the unit substrates. The dummy barrier ribs are close to where the base substrate is divided, such that the dummy barrier ribs of adjacent unit substrates oppose each other. Each unit substrate is separated from another unit substrate along a border at an edge opposite to an edge at which terminals of discharge electrodes and signal transmitting units are connected. This helps prevent noise when a unit substrate is joined with another unit substrate.

### CROSS-REFERENCE TO RELATED PATENT APPLICATION

This application claims priority to and the benefit of Korean Patent Application No. 10-2008-0102556, filed on Oct. 20, 2008, in the Korean Intellectual Property Office, the entire content of which is incorporated herein by reference.

### BACKGROUND

1. Field

The present invention relates to a plasma display panel (PDP) and a PDP fabrication method.

2. Description of the Related Art

Generally, a plasma display panel (PDP) is a flat panel display device that displays desired numbers, characters, or graphics by discharging a plurality of discharge electrodes between two substrates in which a discharge gas has been injected, thereby generating vacuum ultraviolet rays and exciting phosphors in phosphor layers between the substrates.

PDPs can be categorized either by the type of driving voltage applied to discharge cells (i.e. a direct current (DC) type or an alternating current (AC) type) or by the configuration of discharge electrodes (i.e. a two-way discharge type or a surface discharge type).

A conventional three-electrode surface discharge type PDP includes: a front substrate; a rear substrate; a plurality of sustain discharge electrode pairs that are formed on the front substrate, each pair of which includes an X electrode and a Y electrode; a front dielectric layer covering the sustain discharge electrode pairs; a protective layer formed on the front dielectric layer; a plurality of address electrodes formed on the rear substrate and extending in a direction crossing the direction in which the sustain discharge electrode pairs extend; a rear dielectric layer covering the address electrodes; red, green, and blue phosphor layers formed between barrier ribs; and a discharge gas injected into inner spaces formed by joining the front and rear substrates.

In a PDP having the above structure, electric signals are applied to a Y electrode and an address electrode to select a discharge cell. Then, electric signals are alternately applied to X and Y electrodes, so that surface discharge occurs at a surface of a front electrode and vacuum ultraviolet rays are generated from the discharge. As the vacuum ultraviolet rays excite phosphor layers, visible rays are irradiated from the excited phosphor layers. Thus, the PDP can display still images or a motion picture by the visible rays.

Conventional PDPs are manufactured by preparing a single base substrate and dividing the base substrate into a plurality of unit substrates to improve manufacturing yield; i.e. a first substrate, a second substrate, through an n−1^{th} substrate, and an n^{th} substrate.

Depending on their type, various patterned layers are formed on each of the unit substrates. If the unit substrates are front substrates, a plurality of sustain discharge electrode pairs and a front dielectric layer that covers the sustain discharge electrode pairs are formed on each of the unit substrates. In contrast, if the unit substrates are rear substrates, a plurality of address electrodes, a rear dielectric layer that covers the address electrodes, barrier ribs, and phosphor layers are formed on the unit substrates.

After formation of patterned layers on each of the unit substrates, a baking operation is performed. After the baking operation, the base substrate is divided into the unit substrates by cutting along borders between the first substrate, the second substrate, through the n−1^{th} substrate, and the n^{th} substrate by using a cutting tool.

Here, among the various patterned layers, the barrier ribs are patterned by applying a barrier rib raw material on the unit substrates. At this point, the barrier ribs can be formed by using various methods including a sand blast method, an etching method, a laser method, etc.

However, problems as described below may occur in the case where barrier ribs are formed by using the sand blast method.

Referring to FIG. 1, a barrier rib raw material 102 is printed on a conventional substrate 101. A dry film 103 is disposed on the printed barrier rib raw material 102. Next, barrier ribs are patterned by photolithography and shaped by polishing the barrier rib raw material 102 by spraying an abrasive substance in a direction indicated by arrows A using a sander disposed toward the substrate 101. Peripheral portions B of the barrier ribs at the outermost part of the patterned substrate 101 have their middle portions concavely formed due to powder of the barrier rib raw material 102 colliding with the substrate 101 and bouncing back as indicated by arrows C.

When the middle portions of the barrier ribs are concavely formed as described above and the patterned barrier rib raw material 102 are baked, upper and middle portions of the peripheral portions B receive different contraction forces.

While baking the patterned barrier rib raw material 102, the peripheral portions B of the barrier ribs have different contraction forces applied at upper portions D and middle portions E (see FIG. 2). Therefore, sharp protrusion portions are formed at the edge portions of the barrier ribs. Due to the protrusion portions, noise is generated.

In other words, as shown in FIG. 2, the peripheral portions B receive almost no downward vertical contraction force at their upper portions D during the baking operation, and thus there is little change in the height of the barrier ribs at the peripheral portions B. In contrast, the middle portions E receive a downward vertical contraction force similar to that of interior portions 104 of the barrier ribs during the baking operation, and thus the height of the barrier ribs decreases at the middle portions E.

In more detail, during baking/firing, the upper portions D have substantially no vertical contraction force, so that there is almost no change to the height. In contrast, the middle portions E are affected by the vertical contraction forces, such that their height is lowered.

Thus, since the height at the upper portions D is higher than at the middle portions E, there is a height difference H₁ between the height of the peripheral portions B of the barrier ribs at the outermost portion of the substrate 101 and the height of the interior portions 104 of the barrier ribs. Due to the height difference H₁, the upper portions D of the barrier ribs may collide with lower portions of the other substrate after panel assembly. Thus, noise may be generated.

As such, because the middle portions E are compressed downward due to the vertically downward contraction force, due to the difference in the contraction forces between the upper portions D and the middle portions E at the edge portions of the barrier ribs, sharp protrusion portions are formed.

Putting it another way, due to the extra barrier rib raw material that needs to be removed (through sand blasting) at the edges between adjacent unit substrates, paths along which the powder of barrier rib raw material can escape are not secured in spaces between the plurality of barrier ribs disposed at locations close to borders between the first substrate, the second substrate, through the n−1^{th} substrate, and the n^{th} substrate. Therefore, the powder of the barrier rib raw material collides with edge sidewalls of the barrier ribs, and thus the regions at which the powder of the barrier rib raw material collides with the barrier ribs becomes more concave than other remaining regions.

As a result, during the baking operation, the barrier ribs at the locations of the collisions become taller than at the remaining regions of the barrier ribs. Thus, the barrier ribs at these locations may collide with lower portions or dielectric layers of other substrates combined with the unit substrates, which may generate noise after assembling the corresponding pairs of unit substrates.

In other words, at the edge portions of the barrier ribs, there is a height difference H₁ corresponding to the protrusion portions, in comparison to other portions of the barrier ribs. Due to the height difference, there is a phenomenon of the protrusion portions of the barrier ribs colliding with the other substrate after panel assembly, thereby generating noise. Such phenomenon is similar to the edge-curl phenomenon due to the undercut of the electrode.

In particular, in a panel structure in which signal transmitting units such as a tape carrier package (TCP) are connected to terminals of discharge electrodes at edges at which each unit substrate is cut, vibrations of circuit terminals of signal transmitting units during discharge may also generate noise in addition to the noise generated due to the height difference of barrier ribs, and thus the overall noise is more significant.

### SUMMARY

Exemplary embodiments of the present invention provide a PDP in which a base substrate is divided into a plurality of unit substrates such that an edge at which the base substrate is divided is different from an edge at which signal transmitting units are disposed, for noise reduction, and provides a method of fabricating the PDP.

According to an exemplary embodiment of the present invention, a method of fabricating a plasma display panel (PDP) is provided. The method includes: preparing a base substrate to be divided into a plurality of unit substrates; forming a plurality of discharge electrodes and a dielectric layer covering the discharge electrodes on the plurality of unit substrates; patterning barrier ribs on the dielectric layer; and dividing the base substrate along a border between the unit substrates. The barrier ribs include: main barrier ribs in a display area of each of the unit substrates for displaying images; and dummy barrier ribs in a non-display area of each of the unit substrates outside the display area. The dummy barrier ribs are at locations close to where the base substrate is divided, such that the dummy barrier ribs on the unit substrates oppose each other across the border. The unit substrates are separated from each other along the border at an edge opposite to an edge at which terminals of discharge electrodes and signal transmitting units are connected.

According to another exemplary embodiment of the present invention, a plasma display panel (PDP) is provided. The PDP includes: a substrate; discharge electrodes on the substrate; a dielectric layer covering the discharge electrodes; and barrier ribs on the dielectric layer. The barrier ribs include: main barrier ribs in a display area of the substrate for displaying images; and dummy barrier ribs in a non-display area of the substrate outside the display area. The dummy barrier ribs are at locations close to a border of the substrate. Terminals of the discharge electrodes and signal transmitting units are connected at an edge opposite to the border.

### BRIEF DESCRIPTION OF THE DRAWINGS

The above and other features and aspects of the present invention will become more apparent by describing in detail exemplary embodiments thereof with reference to the attached drawings in which:

FIG. 1 is a partially exploded perspective view showing a sand blast operation being performed on a conventional substrate;

FIG. 2 is a perspective view showing the substrate of FIG. 1 after barrier ribs are baked;

FIG. 3 is a partially exploded perspective view of a three-electrode surface discharge type plasma display panel (PDP) according to an embodiment of the present invention;

FIG. 4 is a schematic diagram illustrating discharge electrodes and barrier ribs disposed on front and rear substrates (after assembly) of FIG. 3;

FIG. 5 is a diagram showing how the PDP of FIG. 3, signal transmitting units, and a circuit board are arranged;

FIG. 6 is a diagram showing a base substrate according to an embodiment of the present invention that is divided into two substrates;

FIG. 7 is a diagram showing a base substrate according to another embodiment of the present invention that is divided into two substrates;

FIG. 8 is a sectional view showing a border between the two substrates of FIG. 7 in closer detail; and

FIG. 9 is a sectional view showing a border between two substrates according to an embodiment modified from that of FIG. 7 in closer detail.

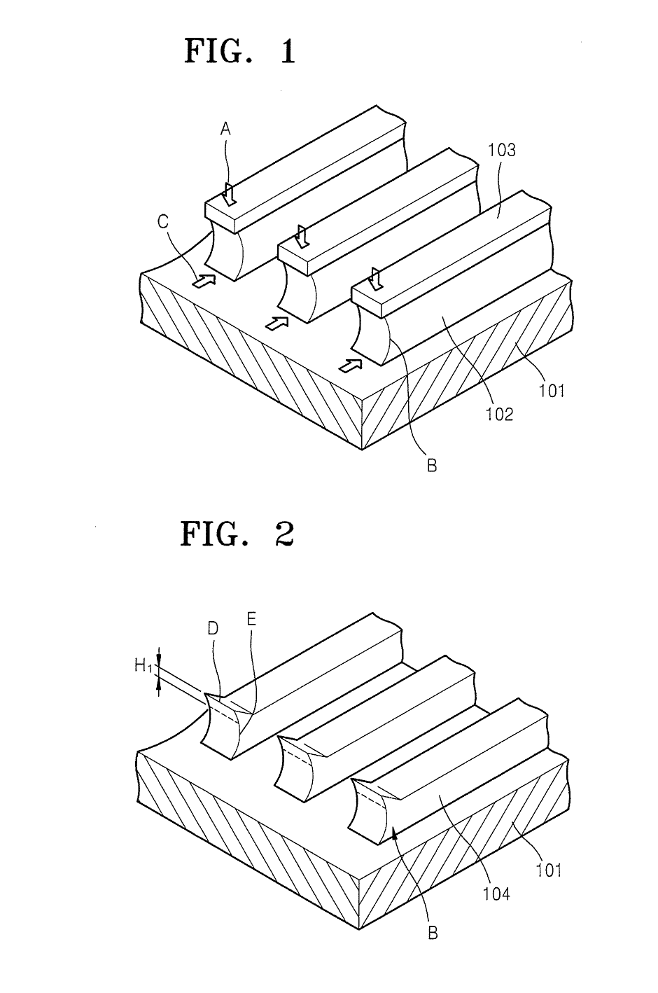

### DETAILED DESCRIPTION

Exemplary embodiments of the present invention will now be described with reference to the attached drawings.

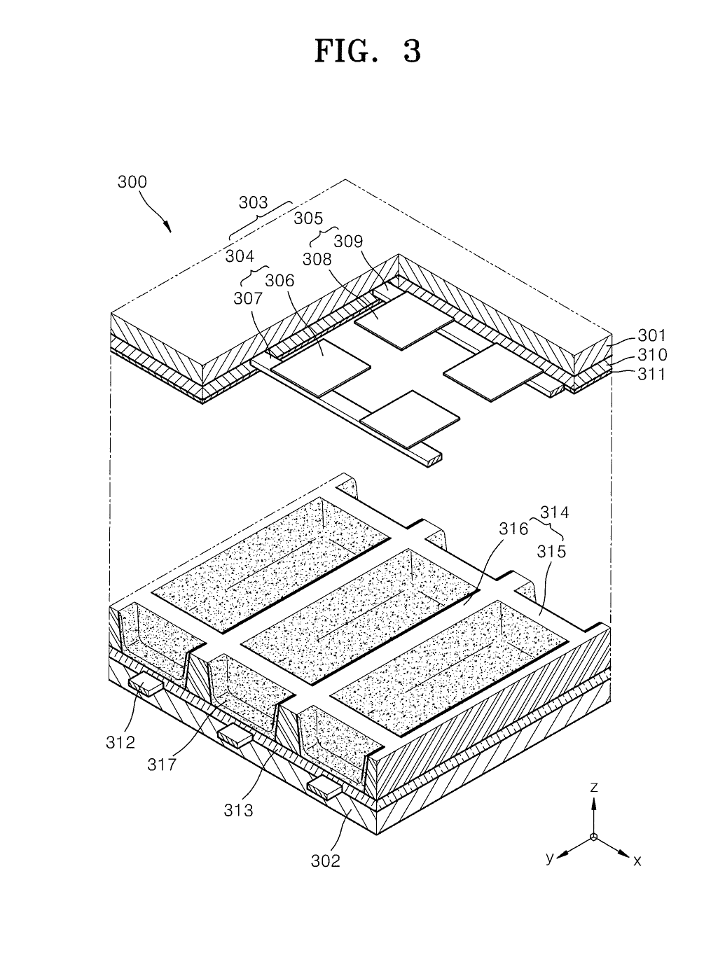

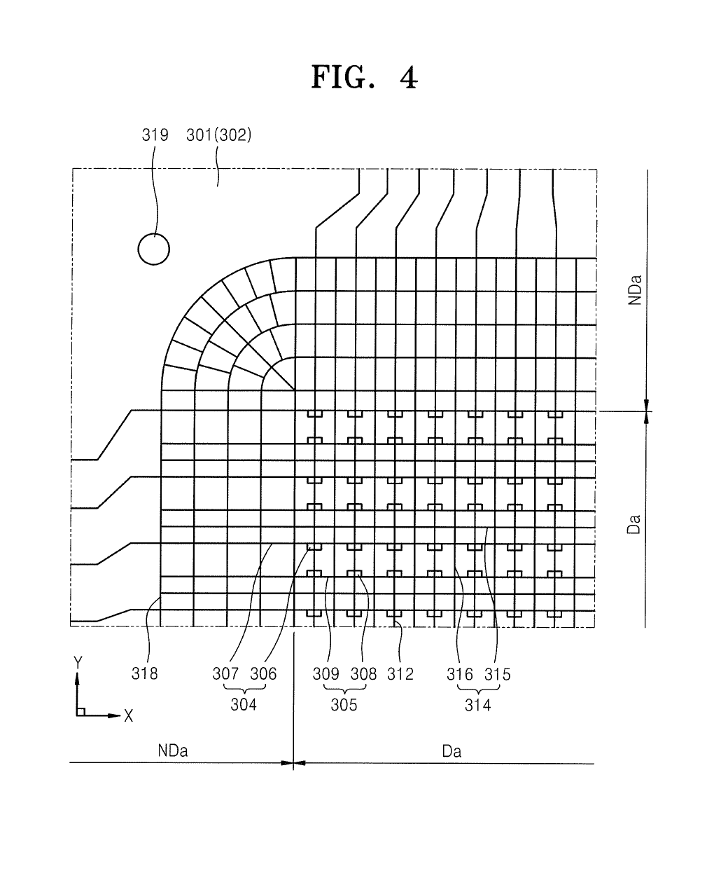

FIG. 3 is a partially exploded perspective view of a three-electrode surface discharge type plasma display panel (PDP) 300 according to an embodiment of the present invention.

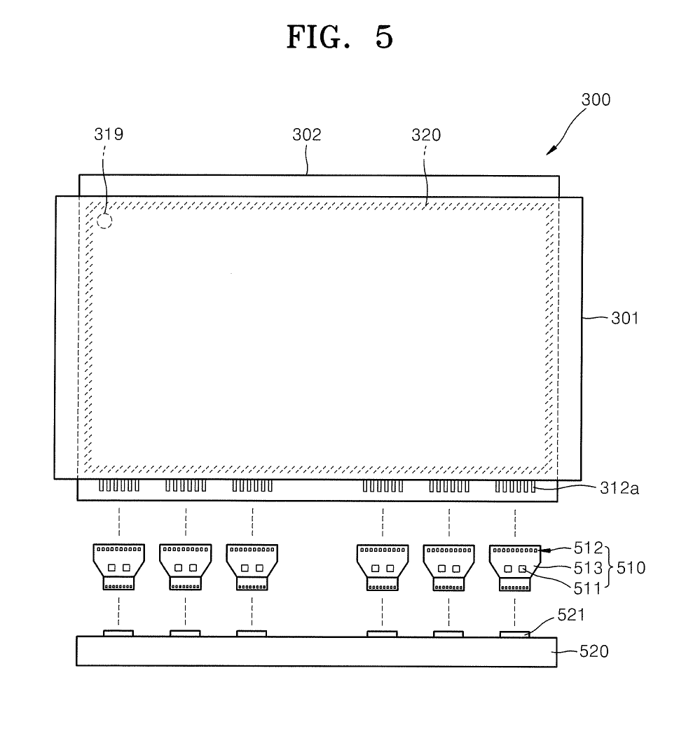

Referring to FIG. 3, the PDP 300 includes a front substrate 301 and a rear substrate 302 facing the front substrate 301. To form a closed discharge space, frit glass (320 of FIG. 5) is applied along edges of inner surfaces of the front substrate 301 and the rear substrate 302.

The front substrate 301 may be, for example, a transparent substrate formed of a soda lime glass, etc., a semi-transmissive substrate, a reflective substrate, or a colored substrate.

Sustain discharge electrode pairs 303 are disposed on the front substrate 301. Each of the sustain discharge electrode pairs 303 includes an X electrode 304 and a Y electrode 305. A sustain discharge electrode pair is disposed in each of a plurality of discharge cells.

The X electrodes 304 include X transparent electrodes 306, each of which is independently disposed in a corresponding discharge cell, and X bus electrode lines 307, each of which extends along discharge cells that are arranged in the X-axis direction and electrically connects the X transparent electrodes 306 corresponding to these discharge cells.

The Y electrodes 305 include Y transparent electrodes 308, each of which is independently disposed in a corresponding discharge cell, and Y bus electrode lines 309, each of which extends along discharge cells that are arranged in the X-axis direction and electrically connects the Y transparent electrodes 308 corresponding to these discharge cells.

The X transparent electrodes 306 and the Y transparent electrodes 308 have, for example, rectangular cross-sections. The X transparent electrodes 306 and the corresponding Y transparent electrodes 308 do not contact each other at the center of their corresponding discharge cells, and are a predetermined distance apart from each other to form discharge gaps. The X bus electrode lines 307 and the Y bus electrode lines 309 are, for example, strip-type lines, disposed at two opposite edges of each of their corresponding discharge cells.

The X transparent electrodes 306 and the Y transparent electrodes 308 are formed of transparent conductive films such as indium tin oxide (ITO) films. The X bus electrode lines 307 and the Y bus electrode lines 309 are formed of, for example, silver paste having excellent conductivity or metals such as chrome-copper-chrome.

The X electrodes and the Y electrodes are covered by a front dielectric layer 310. The front dielectric layer 310 is formed of a transparent dielectric; e.g., a material having high dielectric properties such as PbO—B₂O₃—SiO₂.

A protective layer 311 formed of magnesium oxide (MgO) is formed on the top surface of the front dielectric layer 310 to increase secondary electron emission. The protective layer 311 is deposited onto the top surface of the front dielectric layer 310.

The rear substrate 302 may, for example, be a transparent substrate, a semi-transmissive substrate, a reflective substrate, or a colored substrate. On the rear substrate 302, address electrodes 312 are disposed in a direction crossing the direction of the Y electrodes 305.

The address electrodes 312 are, for example, strip-type electrodes, and extend to cross corresponding discharge cells along the Y-axis of the PDP 300. The address electrodes 312 are covered by a rear dielectric layer 313. The rear dielectric layer 313 is formed of a material having high dielectric properties that, for example, is the same as that of the front dielectric layer 310.

Main barrier ribs 314 are disposed between the front substrate 301 and the rear substrate 302. The main barrier ribs 314 are formed to define discharge cells and to prevent or reduce crosstalk between adjacent discharge cells.

The main barrier ribs 314 include first main barrier ribs 315 extending along the X-axis of the PDP 300 and second main barrier ribs 316 extending along the Y-axis of the PDP 300. The first main barrier ribs 315 and the second main barrier ribs 316 are arranged, for example, to form discharge cells in the form of a matrix.

The structure of the main barrier ribs 314 is not limited thereto, and the main barrier ribs 314 may have any structure as long as the structure can define discharge cells. Furthermore, the shape of cross-sections of discharge cells do not have to be rectangular, but may also be a polygon, a circle, an ellipse, etc.

Discharge gas, such as neon-xenon (Ne—Xe) or helium-xenon (He—Xe), is injected into the discharge spaces defined by the front substrate 301, the rear substrate 302, and the main barrier ribs 314.

Furthermore, phosphor layers 317, which are excited by ultraviolet rays generated from the discharge gas and emit visible rays of various colors, are formed in the discharge cells. In the current embodiment, the phosphor layers 317 are formed on an upper portion of the rear dielectric layer 313 and on inner walls of the main barrier ribs 314.

Here, the phosphor layers 317 include red, green, and blue phosphor layers. However, the present invention is not limited thereto. In the current embodiment, the red phosphor layer is formed of (Y,Gd)BO₃:Eu⁺³, the green phosphor layer is formed of Zn₂SiO₄:Mn²⁺, and the blue phosphor layer is formed of BaMgAl₁₀O₁₇:Eu²⁺.

FIG. 4 is a schematic diagram illustrating discharge electrodes and barrier ribs disposed on the front and rear substrates 301 and 302 of FIG. 3.

Referring to FIG. 4, the combined first and rear substrates 301 and 302 are divided into a display area Da, which is a region for displaying images, and a non-display area NDa, which is defined along edges of the display area Da and is a region for connecting external devices.

In the display area Da, the X and Y electrodes 304 and 305 are alternately arranged along the Y-axis of the substrates and extending in the X-axis direction, and the address electrodes 312 extend in the Y-axis direction of the substrates in a direction crossing that of the X and Y electrodes 304 and 305. Furthermore, the main barrier ribs 314 are disposed in the form of a matrix in the display area Da. A pair of the X and Y electrodes 304 and 305 and an address electrode 312 are disposed in each discharge cell sectioned by the main barrier ribs 314.

Dummy barrier ribs 318 are formed in the non-display area NDa surrounding the display area Da to prevent or reduce a height difference of the main barrier ribs 314 caused by shrinking, so as to prevent or reduce noise. The noise may be generated when the front substrate 301 and the rear substrate 302 are not firmly joined due to the main barrier ribs 314 being bent by the shrinking force. The dummy barrier ribs 318 and the main barrier ribs 314 of the display area Da are formed substantially as a single integrated body, but the present invention is not limited thereto.

An exhaustion hole 319, which provides a path via which impurities remaining in the internal space formed by joining the front substrate 301 and the rear substrate 302 can be exhausted during vacuum exhaustion, is disposed in the non-display area NDa. See FIG. 4.

FIG. 5 is a diagram showing how the PDP 300 of FIG. 3, signal transmitting units 510, and a circuit board 520 are arranged.

Referring to FIG. 5, electrode terminals 312a protrude from positions outside a region formed by overlapping the front and rear substrates 301 and 302 of the PDP 300, wherein the electrode terminals 312a are extended from address electrodes 312 of FIG. 3. The positions from which the electrode terminals 312a protrude are at edges of the PDP 300 at which either the front substrate 301 or the rear substrate 302 are exposed to the outside.

Although only the positions at which the electrode terminals 312a of the address electrodes 312 are shown in FIG. 5, it is clear that electrode terminals extended from the sustain discharge electrode pairs 303 of FIG. 3 also protrude from positions outside the region formed by overlapping the front and rear substrates 301 and 302 of the PDP 300.

The signal transmitting units 510 are interconnected between the electrode terminals 312a and connectors 521 of the circuit board 520, and thus the electrode terminals 312a and connectors 521 of the circuit board 520 can exchange electrical signals. The shape of the signal transmitting units 510 may vary.

According to the present embodiment, each of the signal transmitting units 510 includes a plurality of driving integrated circuits (IC) 511, a lead 512 patterned to be connected to the driving ICs 511, and a film 513 having flexibility to cover the entire lead 512.

At this point, the address electrodes 312 are single scan type. Thus, the address electrodes 312 can scan in a single direction either from the top of the PDP 300 to the bottom of the PDP 300 or vice versa.

Therefore, the address electrodes 312 can be connected to the scan-required signal transmitting units 510 or the circuit board 520 at one edge of the PDP 300, and the signal transmitting units 510 or the circuit board 520 are not required at other edges of the PDP 300. Since the single scan method requires neither signal transmitting units 510 nor a circuit board 520 at other edges of the PDP 300, the cost of fabricating a PDP 300 is significantly reduced.

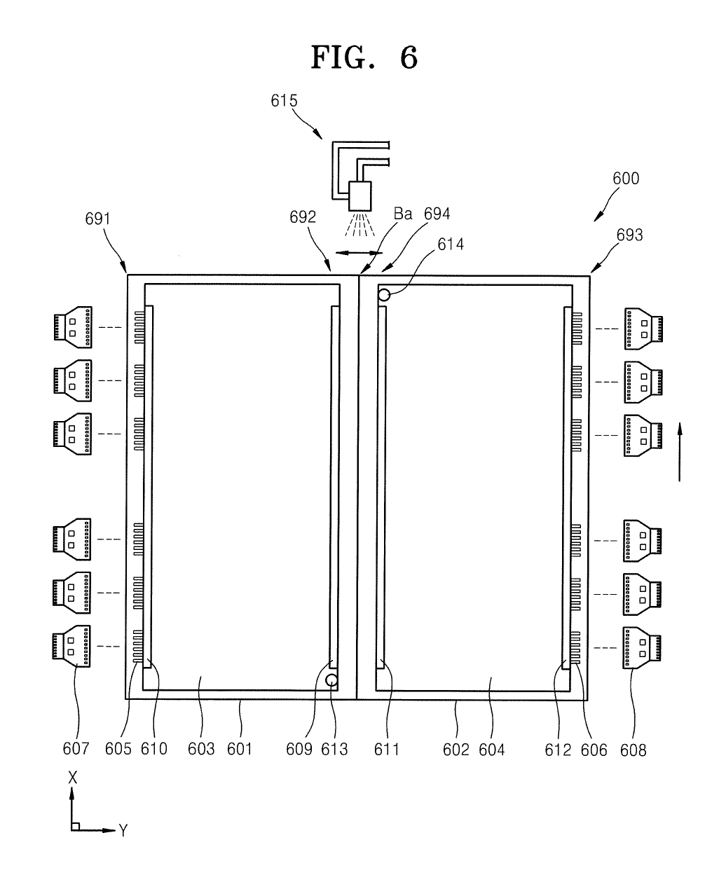

FIG. 6 is a diagram showing a single base substrate 600, according to an embodiment of the present invention, divided into two substrates.

Referring to FIG. 6, the base substrate 600 is divided into a first substrate 601 and a second substrate 602. At this point, each of the first substrate 601 and the second substrate 602 is a unit substrate corresponding to the rear substrate 302 shown in FIGS. 3 through 5. Although a case where the base substrate 600 is divided into two substrates is shown in the current embodiment, it is clear that a base substrate may be divided into more than two substrates, such as a first substrate, a second substrate, through an n−1^{th} substrate and an n^{th} substrate, depending on the size of the base substrates.

A first dielectric layer 603 and a second dielectric layer 604 are coated on the first substrate 601 and the second substrate 602, respectively. It is advantageous for fabrication when the thickness of the first dielectric layer 603 and the thickness of the second dielectric layer 604 are uniform and are substantially equal to each other.

The first dielectric layer 603 covers from near a first edge 691 of the first substrate 601 to a second edge 692 on the first substrate, wherein the second edge 692 is close to a border Ba at which the base substrate 600 is divided into the first and second substrates 601 and 602. The second dielectric layer 604 covers from near a first edge 693 of the second substrate 602 to a second edge 694 on the second substrate, wherein the second edge 694 is close to the border Ba at which the base substrate 600 is divided into the first and second substrates 601 and 602.

First address electrodes (see, for example, address electrodes 312 in FIG. 3) are disposed between the first substrate 601 and the first dielectric layer 603, and the first address electrodes are covered by the first dielectric layer 603. First address electrode terminals 605 are disposed at a first edge region near the first edge 691 of the first substrate 601, wherein the first address electrode terminals 605 are extended from the first address electrodes and are not covered by the first dielectric layer 603.

Furthermore, second address electrodes (see, for example, address electrodes 312 in FIG. 3) are disposed between the second substrate 602 and the second dielectric layer 604, and the second address electrodes are covered by the second dielectric layer 604. Second address electrode terminals 606 are disposed at a first edge region near the first edge 693 of the second substrate 602, wherein the second address electrode terminals 606 are extended from the second address electrodes and are not covered by the second dielectric layer 604.

In the embodiment shown in FIG. 6, the first address electrodes and the second address electrodes are of a single scan type. Thus, the first address electrode terminals 605 can be electrically connected to first signal transmitting units 607 at the first edge 691 of the first substrate 601, while the second address electrode terminals 606 can be electrically connected to second signal transmitting units 608 at the first edge 693 of the second substrate 602. No address electrode terminals are disposed at the side of the border Ba at which the base substrate 600 is divided into the first substrate 601 and the second substrate 602.

First main barrier ribs (see, for example, main barrier ribs 314 in FIGS. 3-4) are disposed on the first dielectric layer 603, and a plurality of first dummy barrier ribs 609 and 610 are connected to the first main barrier ribs at edges of the first main barrier ribs (see, for example, dummy barrier ribs 318 in FIG. 4). Second main barrier ribs (see, for example, main barrier ribs 314 in FIGS. 3-4) are disposed on the second dielectric layer 604, and a plurality of second dummy barrier ribs 611 and 612 are connected to the second main barrier ribs at edges of the second main barrier ribs (see, for example, dummy barrier ribs 318 in FIG. 4).

Although the plurality of first dummy barrier ribs 609 and 610 and the plurality of second dummy barrier ribs 611 and 612 may be disposed in all regions along edges of the first substrate 601 and the second substrate 602, respectively, the present embodiment will be described for a case in which each of the plurality of first dummy barrier ribs 609 and 610 are respectively disposed at two opposite edges of the first substrate 601. In addition, each of the plurality of the second dummy barrier ribs 611 and 612 are respectively disposed at two opposite edges of the second substrate 602, wherein the plurality of first dummy barrier ribs 609 and 610 and the plurality of second dummy barrier ribs 611 and 612 extend in a direction (i.e., X-axis direction) perpendicular to the direction (i.e., Y-axis direction) in which the first address electrode terminals 605 and the second address electrode terminals 606 extend.

As described above, the first dummy barrier ribs 609 and 610 and the second dummy barrier ribs 611 and 612 are disposed at two opposite edges of the respective one of the first substrate 601 and the second substrate 602, respectively, such that one dummy barrier rib 609 of the first dummy barrier ribs and one dummy barrier rib 611 of the second dummy barrier ribs oppose each other across the border Ba. At this point, neither the first dielectric layer 603 nor the second dielectric layer 604 is formed between the one dummy barrier rib 609 and the one dummy barrier rib 611. While the embodiments are being discussed primarily in reference to “one dummy barrier rib” on each side of the border Ba, the present invention is not limited thereto. Depending on the structure of the barrier ribs, multiple barrier ribs on each side of the border Ba may oppose each other.

A first exhaustion hole 613 for vacuum exhaustion of a panel formed by the first substrate 601 and another substrate (see, for example, FIG. 5) is formed near the second edge 692 of the first substrate 601, wherein the second edge 692 is close to the border Ba at which the base substrate 600 is divided into the first substrate 601 and the second substrate 602. Furthermore, a second exhaustion hole 614 for vacuum exhaustion of a panel formed by the second substrate 602 and another substrate (see, for example, FIG. 5) is formed near the second edge 694 of the second substrate 602, wherein the second edge 694 is close to the border Ba at which the base substrate 600 is divided into the first substrate 601 and the second substrate 602.

As described above, the shapes of and layouts on the first and second substrates 601 and 602 are substantially the same as each other. Thus, the first and second dielectric layers 603 and 604, the first and second address electrode terminals 605 and 606, the first and second dummy barrier ribs 609 through 612, and the first and second exhaustion holes 613 and 614 are in the same relative position (e.g., symmetrical) with respect to each other. The first and second address electrodes are of a single scan type.

Thus, the connection between the first address electrode terminals 605 and the first signal transmitting units 607 and the connection between the second address electrode terminals 606 and the second signal transmitting units 608 are respectively made at the first edge 691 of the first substrate 601 and the first edge 693 of the second substrate 602, instead of at the second edges 692 and 694 close to the border Ba.

A process of cutting the base substrate 600 having the above structure will now be described.

First, the base substrate 600, which is to be divided into the first substrate 601 and the second substrate 602, is prepared. However, the present invention is not limited thereto, and the base substrate 600 may be divided into any other suitable number of substrates.

Next, the first address electrodes and the second address electrodes are respectively patterned on the first substrate 601 and the second substrate 602. Then, the first dielectric layer 603 and the second dielectric layer 604, by which the first address electrodes and the second address electrodes are respectively covered, are coated on the first substrate 601 and the second substrate 602, respectively.

The first dielectric layer 603 is coated on the first substrate 601 such that the first address electrode terminals 605 protruding at the first edge 691 of the first substrate 601 are not covered. The second dielectric layer 604 is coated on the second substrate 602 such that the second address electrode terminals 606 protruding at the first edge 693 of the second substrate 602 are not covered, wherein the second substrate 602 has substantially the same shape and layout as the first substrate 601.

Next, a raw material for the first main barrier ribs is coated on the first dielectric layer 603 in the display area of the first substrate 601, and a raw material for a plurality of first dummy barrier ribs, which extends from the raw material for first main barrier ribs, is coated on the first dielectric layer 603 in the non-display area of the first substrate 601. A raw material for the second main barrier ribs is coated on the first dielectric layer 604 in the display area of the second substrate 602, and a raw material for a plurality of second dummy barrier ribs, which extends from the raw material for second main barrier ribs, is coated on the second dielectric layer 604 in the non-display area of the second substrate 602.

In other words, barrier rib raw material is printed on the base substrate 600. After the barrier rib raw material printed on the base substrate 600 is dried, a dry film is disposed on the barrier rib raw material. Then, photolithography is used to pattern shapes of the barrier ribs.

At this point, the base substrate 600 is transported in the X-axis direction to form barrier ribs by using a sand blast method. The barrier ribs formed include the first and second main barrier ribs and the plurality of the first and second dummy barrier ribs 609 through 612 respectively extended from the first and second main barrier ribs.

To accomplish the sand blasting, a sander 615 disposed near the base substrate 600 is swung in a direction perpendicular (i.e., Y-axis direction) to the direction in which the base substrate 600 is moved to jet an abrasive substance such as calcium carbonate (CaCO₃) onto the base substrate 600 under high pressure to remove the printed barrier rib raw material in remaining portions of the base substrate 600 other than portions of the base substrate 600 in which barrier ribs are to be formed and to peel off remaining dry film. Accordingly, the first and second main barrier ribs and the plurality of first and second barrier ribs 609 through 612 can be formed as desired.

As a result, one dummy barrier rib 609 of the first dummy barrier ribs 609 and 610 and one dummy barrier rib 611 of the second dummy barrier ribs 611 and 612 are disposed at the border Ba to oppose each other.

After the first and second address electrodes, the first and second dielectric layers 603 and 604, the first and second main barrier ribs, and the first and second dummy barrier ribs 609 through 612 are respectively formed on the first and second substrates 601 and 602, the base substrate 600 is cut to separate the first substrate 601 and the second substrate 602 from each other.

At this point, the base substrate 600 is cut at the border Ba between the second edges 692 and 694 of the first and second substrates 601 and 602, respectively, wherein the second edges 692 and 694 of the first and second substrates 601 and 602 are respectively the opposite edges of the first edges 691 and 693 of the first and second substrates 601 and 602 at which the first and second address electrode terminals 605 and 606 are respectively connected to the first and second signal transmitting units 607 and 608.

Accordingly, when the barrier ribs are formed by using the sand blast method, edge sidewalls of the dummy barrier ribs 609 and 611 may be etched further than barrier ribs at other locations. This is due to the powder of the barrier rib raw material colliding with the edge sidewalls of the barrier ribs 609 and 611 during sand blasting between the dummy barrier ribs 609 and 611 close to the border Ba. Note that the first and second address electrode terminals 605 and 606 are respectively connected to the first and second signal transmitting units 607 and 608 at the opposite side of the border Ba. Thus, less noise is generated as compared to a case in which address electrode terminals are connected to signal transmitting units at the side of the border Ba.

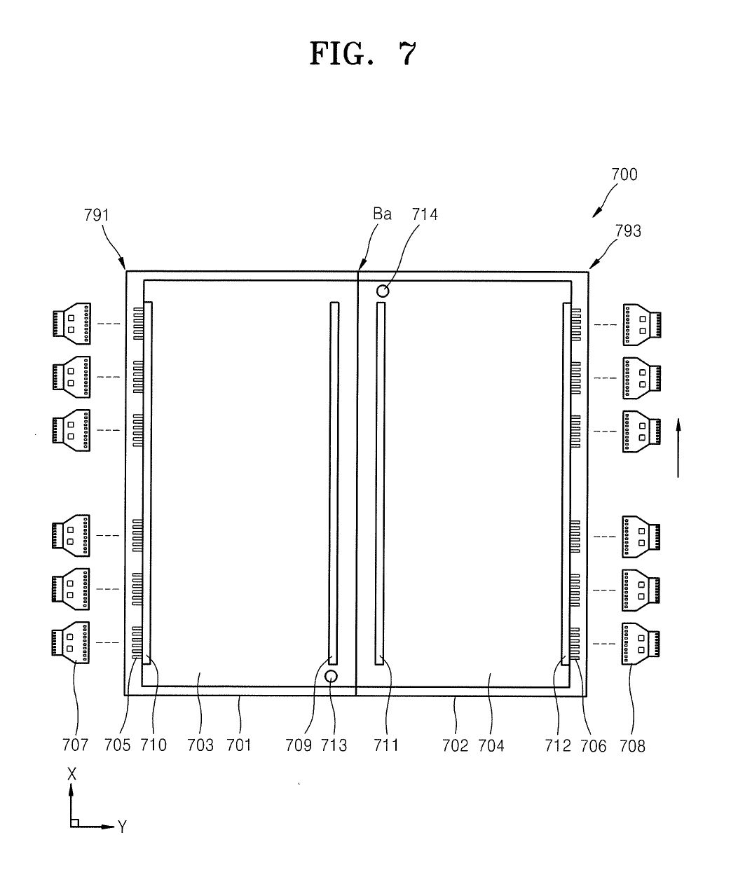

FIG. 7 is a diagram showing a base substrate 700 according to another embodiment of the present invention that is divided into two substrates.

In the present embodiment, a dielectric layer is applied to cover a border Ba at which the base substrate 700 is divided into a first substrate 701 and a second substrate 702 for further noise reduction in the PDP of the previous embodiment.

Referring to FIG. 7, the base substrate 700 is divided into the first substrate 701 and the second substrate 702. The top surfaces of the first substrate 701 and the second substrate 702 are coated with a first dielectric layer 703 and a second dielectric layer 704, respectively.

The first dielectric layer 703 covers from near a first edge 791 of the first substrate 701 to the border Ba, and the second dielectric layer 704 covers from near a first edge 793 of the second substrate 702 to the border Ba. Thus, the border Ba at which the base substrate 700 is divided into the first substrate 701 and the second substrate 702 is covered by the first dielectric layer 703 and/or the second dielectric layer 704.

First address electrode terminals 705 are disposed at a first edge region near the first edge 791 of the first substrate 701, wherein the first address electrode terminals 705 are not covered by the first dielectric layer 703. The first address electrode terminals 705 are electrically connected to first signal transmitting units 707.

Second address electrode terminals 706 are disposed at a first edge region near the first edge 793 of the second substrate 702, wherein the second address electrode terminals 706 are not covered by the second dielectric layer 704. The second address electrode terminals 706 are electrically connected to second signal transmitting units 708.

Furthermore, a plurality of first dummy barrier ribs 709 and 710 are disposed at two opposite edges of the first dielectric layer 703, and a plurality of second dummy barrier ribs 711 and 712 are disposed at two opposite edges of the second dielectric layer 704.

A first exhaustion hole 713 for vacuum exhaustion of a panel formed by the first substrate 701 and another substrate (see, for example, FIG. 5) is formed through the first substrate 701, and a second exhaustion hole 715 for vacuum exhaustion of a panel formed by the second substrate 702 and another substrate (see, for example, FIG. 5) is formed through the second substrate 702 at a same relative location to that of the first exhaustion hole 713.

Unlike the previous embodiment, the first dielectric layer 703 and the second dielectric layer 704 are continuously formed to cover the border Ba.

The thickness of the first dielectric layer 703 and the second dielectric layer 704 at the border Ba may be substantially equal to that of the first dielectric layer 703 and the second dielectric layer 704 at other regions of the base substrate 700.

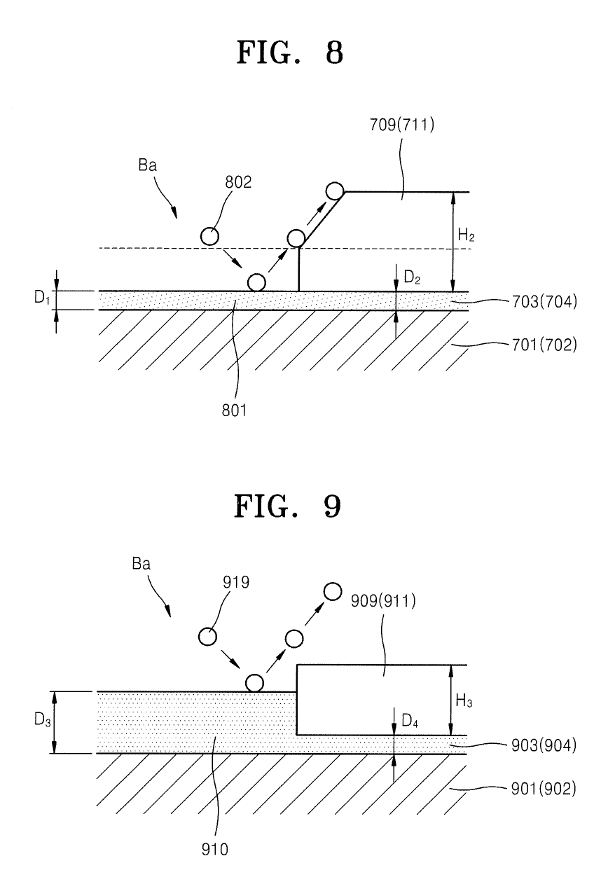

In other words, referring now to FIG. 8, a borderline dielectric layer 801 integrally extending from either the first dielectric layer 703 or the second dielectric layer 704 is formed at the border Ba. The thickness D₁ of the borderline dielectric layer 801 is formed to be substantially equal to the thickness D₂ of the first dielectric layer 703 and the second dielectric layer 704.

The thickness D₁ of the borderline dielectric layer 801 is between about 10 percent and about 15 percent of the height H₂ of the first dummy barrier ribs 709 and the second dummy barrier ribs 711. For example, if the height H₂ of the first dummy barrier ribs 709 and the second dummy barrier ribs 711 is between 110 micrometers and 120 micrometers, the thickness D₁ of the borderline dielectric layer 801 may be formed to be around 15 micrometers.

Accordingly, etching of the lower portions of the first dummy barrier ribs 709 and the second dummy barrier ribs 711 by the powder 802 of the barrier rib raw material can be reduced by forming the borderline dielectric layer 801 having the thickness D₁ at the border Ba. Furthermore, angles at which the powder 802 of the barrier rib raw material is bounced back differ, so that etching of the middle portions of the first dummy barrier ribs 709 and the second dummy barrier ribs 711 by the powder 802 of the barrier rib raw material can be reduced. Thus, noise can be further reduced.

FIG. 9 is a diagram showing the thickness of a dielectric layer according to another embodiment of the present invention.

Referring to FIG. 9, a borderline dielectric layer 910, which extends from either the first dielectric layer 903 or the second dielectric layer 904, is integrally formed at a border Ba at which a base substrate is divided into a first substrate 901 and a second substrate 902.

Here, the thickness D₃ of the borderline dielectric layer 910 is formed to be greater than the thickness D₄ of a first dielectric layer 903 and a second dielectric layer 904. In other words, the thickness D₃ of the borderline dielectric layer 910 is between about 30 percent and about 75 percent of the height H₃ of first dummy barrier ribs 909 and second dummy barrier ribs 911. For example, if the height H₃ of the first dummy barrier ribs 909 and the second dummy barrier ribs 911 is between 110 micrometers and 120 micrometers, the thickness D₃ of the borderline dielectric layer 910 may be formed to be between about 30 micrometers and 90 micrometers.

Accordingly, etching of middle portions of the first dummy barrier ribs 909 and the second dummy barrier ribs 911 by powder 919 of the barrier rib raw material can be further reduced by forming the borderline dielectric layer 910 having the thickness D₃ at the border Ba.

Table 1 shows a noise reduction effect observed in experiments performed using embodiments of the present invention.

TABLE 1

| | Noise (dB) |
|---|---|
| Comparative Example | 27 |
| Embodiment 1 | 24 |
| Embodiment 2 | 20 |
| Embodiment 3 | 17 |

Here, the comparative example is a case where terminals of discharge electrodes and signal transmitting units are connected at a border where a base substrate is divided into a plurality of substrates. The embodiment 1 is in regard to a structure in which a base substrate includes a plurality of substrates symmetrically disposed, where terminals of single scan type discharge electrodes (such as address electrodes) and signal transmitting units are combined at two opposite edges of the base substrate. The embodiment 2 is in regard to a structure in which a dielectric layer is formed on a border of the base substrate of the embodiment 1 at the same thickness as that of dielectric layers at remaining regions of the base substrate. The embodiment 3 is in regard to a structure in which a dielectric layer is formed on a border of the base substrate of the embodiment 1 at a thickness greater than that of dielectric layers at remaining regions of the base substrate.

Referring to Table 1, while a PDP of the comparative example generates 27 dB of noise, PDPs of the embodiments 1 through 3 respectively generate 24 dB, 20 dB, and 17 dB of noise. Accordingly, the PDPs of the embodiments 1 through 3 generate noise reduced by between 3 dB and 10 dB as compared to the PDP of the comparative example.

As described above, a PDP and a method of fabricating the same according to embodiments of the present invention can reduce noise when the PDP substrates are joined since terminals of discharge electrodes and signal transmitting units are connected in a side opposite to a side at which a base substrate is cut to be divided into a plurality of unit substrates.

Furthermore, even if dummy barrier ribs are installed at a location close to a border where the base substrate is divided into a plurality of unit substrates, since terminals of discharge electrodes and signal transmitting units are connected to each other at the opposite side, noise can still be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of fabricating a plasma display panel (PDP), the method comprising:
preparing a base substrate to be divided into a plurality of unit substrates;
forming a plurality of discharge electrodes and a dielectric layer covering the discharge electrodes on the plurality of unit substrates;
patterning barrier ribs on the dielectric layer, wherein the barrier ribs comprise:
main barrier ribs in a display area of each of the unit substrates for displaying images; and
dummy barrier ribs in a non-display area of each of the unit substrates outside the display area; and
dividing the base substrate along a border between the unit substrates,
wherein the dummy barrier ribs are at locations close to where the base substrate is divided, such that the dummy barrier ribs on the unit substrates oppose each other across the border, and
the unit substrates are separated from each other along the border at an edge opposite to an edge at which terminals of discharge electrodes and signal transmitting units are connected.

2. The method of claim 1, wherein the unit substrates adjacent to each other have formed thereon discharge electrodes, dielectric layers, and barrier ribs that are symmetrically arranged.

3. The method of claim 1, wherein the barrier ribs are patterned into main barrier ribs and dummy barrier ribs by using a sand blast method.

4. The method of claim 3, wherein a direction in which the base substrate is transported and a direction in which a sander is swung are perpendicular to each other.

5. The method of claim 1, wherein exhaustion holes for vacuum exhaustion are formed at locations close to the border between the unit substrates.

6. The method of claim 1, wherein the dielectric layer is patterned on each of the unit substrates to cover the border between the unit substrates.

7. The method of claim 6, wherein a thickness of the dielectric layer at the border and a thickness of the dielectric layer on each of the unit substrates are substantially the same.

8. The method of claim 7, wherein the thickness of the dielectric layer at the border is between about 10 percent and about 15 percent of a height of the barrier ribs.

9. The method of claim 6, wherein a thickness of the dielectric layer at the border is greater than a thickness of the dielectric layer at remaining regions of the base substrate.

10. The method of claim 9, wherein the thickness of the dielectric layer at the border is between about 30 percent and about 75 percent of a height of the barrier ribs.

11. The method of claim 1, wherein the discharge electrodes are patterned in a direction perpendicular to a direction along which the base substrate is divided into the plurality of unit substrates.

12. The method of claim 11, wherein the discharge electrodes are patterned in a plurality of single lines extending from an edge to an opposite edge in each of the unit substrates.

13. A plasma display panel (PDP) comprising:
a substrate;
discharge electrodes on the substrate;
a dielectric layer covering the discharge electrodes; and
barrier ribs on the dielectric layer, wherein the barrier ribs comprise:
main barrier ribs in a display area of the substrate for displaying images; and
dummy barrier ribs in a non-display area of the substrate outside the display area,
wherein the dummy barrier ribs are at locations close to a border of the substrate, and
terminals of the discharge electrodes and signal transmitting units are connected at an edge opposite to the border.

14. The PDP of claim 13, wherein the dielectric layer extends to the border.

15. The PDP of claim 14, wherein a thickness of the dielectric layer at the border and a thickness of the dielectric layer at remaining regions of the substrate are substantially the same.

16. The PDP of claim 15, wherein the thickness of the dielectric layer at the border is between about 10 percent and about 15 percent of a height of the barrier ribs.

17. The PDP of claim 14, wherein a thickness of the dielectric layer at the border is greater than a thickness of the dielectric layer at remaining regions of the substrate.

18. The PDP of claim 17, wherein the thickness of the dielectric layer at the border is between about 30 percent and about 75 percent of a height of the barrier ribs.
